(19) United States
(12) Patent Application Publication
(10) Pub. No.: US 2018/0176136 A1
(43) Pub. Date: Jun. 21, 2018

(54) TCP Bufferbloat Resolution

(71) Applicant: MEDIATEK INC., Hsinchu (TW)

(72) Inventors: Yung-Chun Yang, Hsinchu (TW); Cheng-Jie Tsai, Hsinchu (TW); Tsern-Huei Lee, Hsinchu (TW); Guan-Yu Lin, Hsinchu (TW); Yung-Hsiang Liu, Hsinchu (TW); Jun-Hua Chou, Hsinchu (TW); Chia-Chun Hsu, Hsinchu (TW)

(21) Appl. No.: 15/844,730

(22) Filed: Dec. 18, 2017

Related U.S. Application Data
(60) Provisional application No. 62/436,014, filed on Dec. 19, 2016.

(51) Int. Cl. H04L 12/801; H04L 12/807

(52) U.S. Cl. CPC H04L 47/12; H04L 47/283; H04L 47/27; H04L 47/193

(57) ABSTRACT

Apparatus and methods are provided for TCP bufferbloat resolution. In one novel aspect, the TCP client monitors a TCP throughput, determines a TCP throughput stability based on a changing rate of the TCP throughput, adjusts a RWND size dynamically based on the determined TCP throughput stability, and sends the dynamically adjusted RWND size to the TCP server for flow control. In one embodiment, the TCP throughput is stable if the changing rate of an increase or decrease of the TCP throughput is smaller than a threshold, otherwise, the TCP throughput is unstable. The TCP client decreases the RWND size if the TCP throughput is stable, otherwise the TCP client increases the RWND size. In one embodiment, the increase of the RWND size uses the default RWND size adjustment method and the decrease of the RWND size is further depending on the increasing or decreasing state of the TCP client.

### CROSS REFERENCE TO RELATED APPLICATIONS

This application claims priority under 35 U.S.C. § 119 from U.S. Provisional Application No. 62/436,014 entitled “METHOD FOR TCP BUFFERBLOAT RESOLUTION” filed on Dec. 19, 2016, the subject matter of which is incorporated herein by reference.

### TECHNICAL FIELD

The disclosed embodiments relate generally to network communication, and, more particularly, to TCP buffer bloat resolution.

### BACKGROUND

Data communication network has grown exponentially. In the next generation cellular network, known as the 5G network, the supported data rate would be significantly increased. To support high data rate, the communication network, such as the cellular network provides huge buffer size for buffering data to be transmitted through air interface. However, with a large buffer size TCP server tends to excessively increase congestion window (CWND) size, aggressively push too many packets to the flight, and overload the network. As a result, TCP round trip time (RTT) becomes excessively long, and TCP throughput may be significantly reduced due to packet loss. The problem is known as TCP buffer-bloat.

Different proposals try to resolve this problem. However, each with their limitations and drawbacks. For example, a first proposal is to set the RWND as the multiple of bandwidth-delay product (BDP) to avoid excessive transmission rate. The main drawback of DRWA is that it lacks competitiveness to other TCP congestion control methods. If a new TCP connection is built and takes some bandwidth, this solution will observe the decrease of allocated bandwidth and thus decrease RWND. The released quantity of bandwidth will be taken by its competitor. In a second proposal, a complicated mathematical model is used to calculate a suitable RWND size. The second proposal can achieve competitiveness and resolve TCP buffer-bloat at the same time. However, the proposed solution makes assumption on the relation between packet loss and queuing length. It could not be so flexible and efficient to deal with TCP buffer-bloat when the assumption is not valid in considered scenarios. In a third proposal, a method is used to control the RWND size based on only the ratio of average RTT to the minimum RTT. If the ratio is large, the RWND size is reduced otherwise, the RWND size is increased. The third proposal adjusts the RWND size has a drawback of not considering the TCP throughput. Therefore, it may result in severe TCP throughput degradation. For example, when multiple TCP connections compete for the bandwidth, the TCP connection applying the third proposal will try to reduce its RWND size since it detects a long TCP RTT. However, once the TCP connection reduces its RWND size, its TCP throughput will be reduced and the released bandwidth will be taken by its competitor. If the TCP RTT is not reduced, the RWND size for this TCP connection will be further reduced resulting in even smaller TCP throughput even though the long TCP RTT is due to the excessive packets from its competitors rather than itself.

Improvements and enhancements are required for TCP bufferbloat resolution.

### SUMMARY

Apparatus and methods are provided for TCP bufferbloat resolution. In one novel aspect, the TCP client monitors a TCP throughput, determines a TCP throughput stability based on a changing rate of the TCP throughput, adjusts a RWND size dynamically based on the determined TCP throughput stability, and sends the dynamically adjusted RWND size to the TCP server for flow control. In one embodiment, the TCP throughput is stable if the changing rate of an increase or decrease of the TCP throughput is smaller than a threshold, otherwise, the TCP throughput is unstable. In one embodiment, the changing rate is obtained based on a current throughput measurement of the TCP throughput for a predefined period, and an estimated exponential weighted moving average (EWMA) of the current throughput measurement. In another embodiment, the TCP client decreases the RWND size if the TCP throughput is determined to be stable, otherwise the TCP client increases the RWND size. In yet another embodiment, the TCP client enters and stays in a decreasing state if the TCP throughput is determined to be stable, and enters and stays in an increasing state if the TCP throughput is determined to unstable. In one embodiment, the RWDN is decreased based on a minimum round-trip time (RTT), an estimated exponential weighted moving average (EWMA) of a current throughput measurement, and a RWND estimation upper bound factor if the TCP client is in the decreasing state. In another embodiment, the RWDN size reduced by a RWND decreasing ratio based on a current RWDN size if the TCP client is in the decreasing state.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary communication network with TCP bufferbloat resolution in accordance with embodiments of the current invention.

FIG. 2 illustrates an exemplary diagram of the relationship between the RWND and the TCP throughput and the TCP RTT with a TCP throughput in stable and unstable state in accordance with embodiments of the current invention.

FIG. 3 illustrates a flow diagram for the TCP buffer over bloat resolution based on the TCP throughput stability in accordance to embodiments of the current invention.

FIG. 4 illustrates an exemplary TCP throughput stability state transition diagram in accordance with embodiments of the current invention.

FIG. 5 illustrates an exemplary flow chart for RWDN size management based on the TCP throughput stability with the TCP client in the increasing state in accordance with embodiments of the current invention.

FIG. 6 illustrates an exemplary flow chart for RWDN size management based on the TCP throughput stability with the TCP client in the decrease state in accordance with embodiments of the current invention.

FIG. 7 illustrates an exemplary flow chart of a TCP client performing the TCP bufferbloat resolution in accordance with embodiments of the current invention.

FIG. 8 illustrates an exemplary flow chart of a TCP server performing the TCP bufferbloat resolution in accordance with embodiments of the current invention.

### DETAILED DESCRIPTION

Reference will now be made in detail to some embodiments of the invention, examples of which are illustrated in the accompanying drawings.

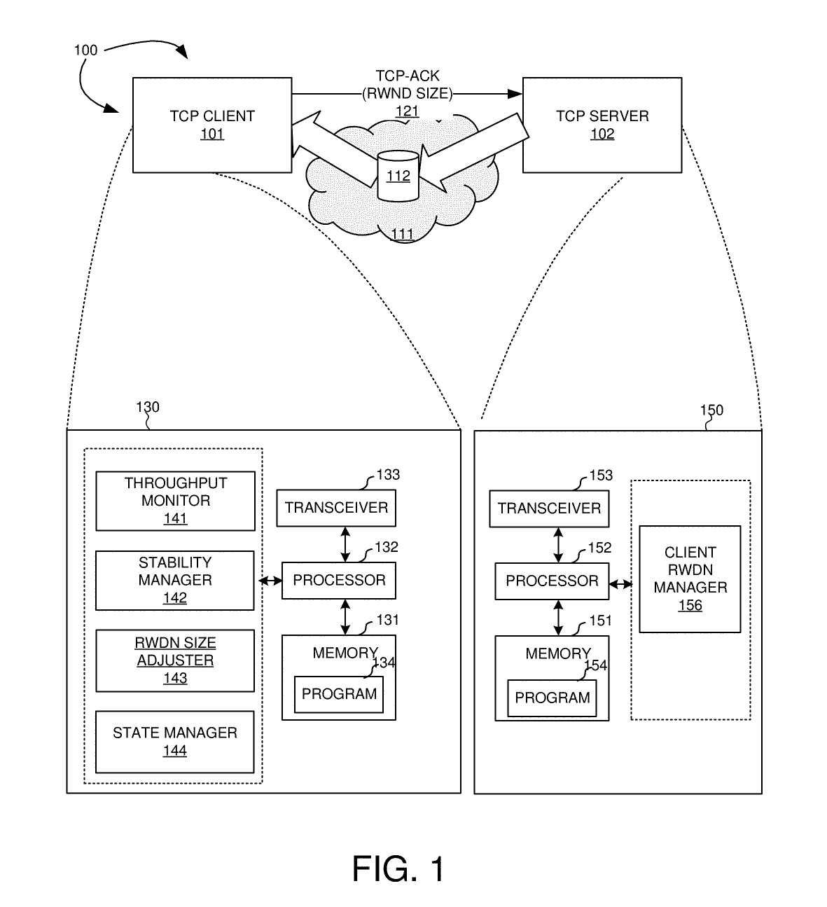

FIG. 1 is a schematic system diagram illustrating an exemplary communication network 100 with TCP bufferbloat resolution in accordance with embodiments of the current invention.

Communication network 100 includes a TCP client 101 and a TCP server 102. TCP server 102 sends data packets to TCP client 101 through an internet 111. The TCP server also has a inter-media data buffer 112 for the communication with TCP client 101. In a high data network, TCP server 102 has a trend to overshoot its congestion windows size (CWND) and push too many packets to the network. As a result, TCP data is prone to suffer from excessive TCP RTT and packet jitter due to long queuing delay in these inter-mediate nodes.

TCP congestion control is performed by the TCP server (sender), and each TCP sender keeps a congestion window size (CWND). CWND is the maximum number of bytes that can be transmitted to the network without receiving acknowledgement (TCP ACK). In the beginning or initialization of a TCP congestion control, CWND is small and TCP sender sends only a few segments to the network to probe the bandwidth. If TCP ACK corresponding to the sent data can be successfully received by TCP sender, then the TCP sender will increase CWND and push more TCP segments to the network. In contrast, if TCP sender detects congestion signal such as receiving duplicated ACK, timeout event occurs, or excessive TCP round trip time (RTT), the sender will decrease CWND and thus reduce the sending rate of TCP segments. There are two categories of TCP congestion controls. The first is the loss-based congestion control and the second is the delay-based congestion control. For loss-based methods, the congestion signal is packet loss, such as TCP Reno and TCP Cubic. For the delay-based methods, the congestion signal is excessive RTT, such as TCP Vegas.

To achieve the maximal TCP throughput and short queuing latency, CWND has its optimal value at the BDP. For example, BDP=BW*RTT, where RTT is the TCP round trip time, and BW means the minimal bandwidth of all the links of the TCP path between TCP server and TCP client. If CWND is smaller than BDP, the bandwidth cannot be fully utilized. This is given CWND less than BDP, too few data bytes are in the flight. As a result, inter-mediate nodes will have idle time to wait for arriving packets to be transmitted. To ensure high bandwidth utilization for large BDP link, buffer size of inter-mediate nodes and the TCP clients are usually set much larger than BDP to ensure that all the data in the flight can be stored in the buffer. In particular, in a cellular network a base station usually assign each mobile station with a huge buffer size to absorb errors from channel variation and support high data rate.

TCP bufferbloat happens due to two main factors, the loss-based TCP congestion control methods and larger buffer size in the inter-mediate nodes. The two factors cause an excessive latency for TCP server 102 to detect congestion and boost CWND. The loss-based TCP congestion control methods allow TCP server 102 to increase CWND until TCP congestion signal is detected. For example, in some scenarios, congestion signal is detected as late as TCP server 102 receives duplicated ACKs or detects TCP packet timeout. Therefore, TCP packet sending rate is much larger than the bottleneck link bandwidth and causes a rapidly growing packet queue in the inter-mediate node. At the same time, the CWND size will still be increased as long as current congestion level do not trigger TCP congestion signal. Therefore, there is a latency gap when TCP server 102 overshoot CWND and when TCP congestion signal is created and detected.

In addition to loss-based TCP congestion control, the other essential factor to cause TCP bufferbloat is the huge buffer size of inter-mediate node, such as the queue for each mobile station in the base station. If the buffer size is large, the excessive number of transmitted packets will be queued in the buffer, and TCP sender will not be informed of the overshoot CWND.

The TCP bufferbloat is mainly for loss-based TCP congestion control. In contrast, delay-based TCP congestion control such as TCP Vegas is resistive to TCP bufferbloat because CWND will be reduced once the TCP server finds that the TCP RTT is excessively long. However, delay-based TCP congestion control has the problem of low resource utilization because there might be no sufficient packets pushed to the network to utilize the bandwidth.

There are two main impacts of TCP bufferbloat on TCP performance: the first is that TCP RTT is excessively larger than expected, and the second is that TCP throughput is frequently cut by TCP server. The bloated CWND causes an overwhelming number of packets in queue, and leads to network overload and packet loss. When detecting congestion signal such as the reception of duplicated ACKs, TCP server 102 will significantly reduce CWND, and thus cause TCP throughout degradation.

TCP bufferbloat occurs when CWND is large and the queue is long. For example, TCP bufferbloat may happen when several TCP connections compete for limited bandwidth, or when running a large BDP link, such as in the 4G or 5G cellular network to support very high data rate.

In one novel aspect, a modified CWDN handling is provided. A receiver-centric solution is provided to resolve the TCP bufferbloat. In one embodiment, TCP client 101 adjusts the feedback value, such as the RWND size value, to eliminate excessive TCP RTT while reaching the bottleneck link throughput at the same time. TCP client 101 increase or decrease the CWDN size dynamically based on the stability of the TCP throughput. At step 121, TCP client 101 transmits the adjusted CWDN size to TCP sever 102. In one embodiment, TCP client 101 sends the feedback, such as the CWDN size, on the existing field of TCP ACK header. There is no need to modify TCP protocol and the existing TCP congestion control method. There is no need to increase any additional feedback signaling for TCP.

In one embodiment, upon receiving the feedback information from TCP client 101, TCP server 102 performs congestion control based on the received feedback information. In current TCP specification, TCP transmission window size is given by the minimum of TCP server 102's congestion window size (CWND), and TCP client 101's receiving window (RWND). For example, TCP TX window size=Min(CWND, RWND). RWND is for TCP client to reflect the buffer size that are available to receive more data from the TCP server. For example, as the implementation in Linux, RWND is always larger than CWND, and RWND value grows until it reaches the bound of TCP receiver memory. In current Linux implementation, TCP client sends RWND value back to TCP server by setting RWND in TCP ACK header.

FIG. 1 further illustrates simplified block diagrams 130 and 150 for TCP client 101 and TCP server 102, respectively. TCP client 101 has a transceiver module 133, which receives communication signals and TCP data packets and sends them to processor 132. Transceiver 133 also converts received signals and data packets from processor 132, converts them transmission packets, and sends out to network 100. Processor 132 processes the received signals and data packets and invokes different functional modules to perform features in TCP client 101. Memory 131 stores program instructions and data 134 to control the operations of TCP client 101.

TCP client 101 also includes multiple function modules that carry out different tasks in accordance with embodiments of the current invention. A throughput monitor 141 monitors a TCP throughput. A stability manager 142 determines a TCP throughput stability based on a changing rate of the TCP throughput. A RWDN size adjuster 143 adjusts a RWND size dynamically based on the determined TCP throughput stability. A state manger 144 enters and stays in a decreasing state if the TCP throughput is determined to be stable, and enters and stays in an increasing state if the TCP throughput is determined to unstable.

Also shown in FIG. 1 is exemplary block diagram for TCP server 102. TCP server 102 has a transceiver module 153, which receives signals and TCP data packets and sends them to processor 152. Transceiver 153 also converts received signals and data packets from processor 152, converts transmission packets and sends out to communication network 100. Processor 152 processes the received signals and data packets and invokes different functional modules to perform features in TCP server 102. Memory 151 stores program instructions and data 154 to control the operations of TCP server 102. TCP server 102 also includes function modules that carry out different tasks in accordance with embodiments of the current invention. A client RWDN manager 156 performs functions to support TCP bufferbloat resolution on TCP server 102.

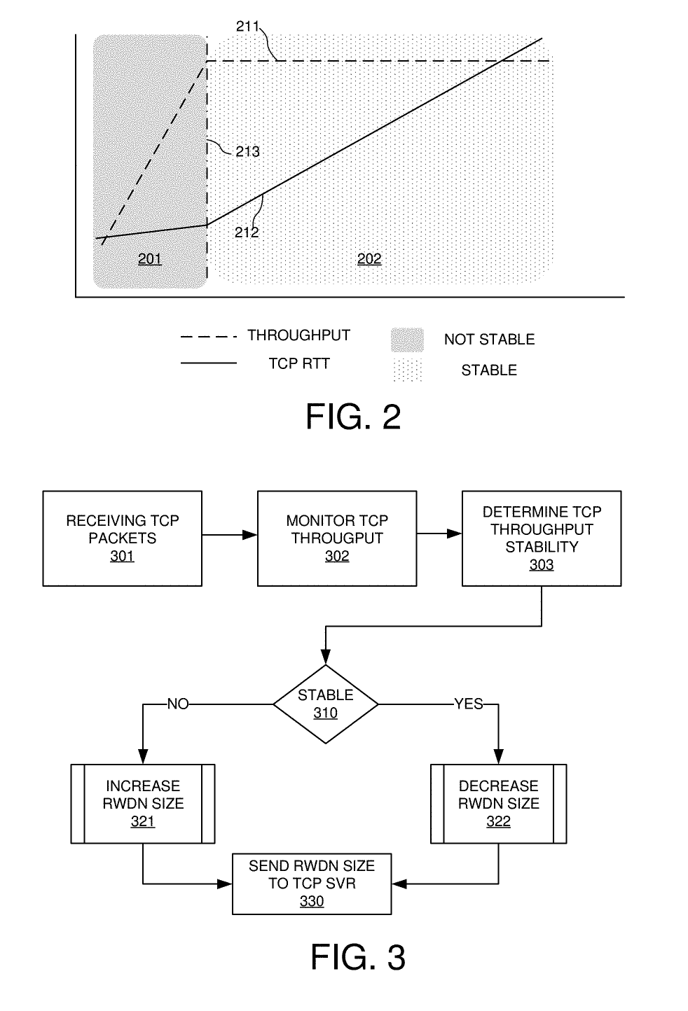

TCP bufferbloat comes from excessive transmission rate, so the TCP client could select a small RWND to reduce transmission rate, and thus eliminate TCP bufferbloat. However, if we set RWND too small, the TCP tx window size would be too small to let each inter-mediate node always transmitting data. The communication results in a low bandwidth utilization and a low throughput. The relation between RWND to TCP throughput and to TCP RTT can be conceptually depicted as in FIG. 2.

FIG. 2 illustrates an exemplary diagram of the relationship between the RWND and the TCP throughput and the TCP RTT with a TCP throughput in stable and unstable state in accordance with embodiments of the current invention. As RWND increases, it is expected to have larger transmission rate and longer packet queue, and thus have longer queuing delay and extended TCP RTT. In contrast, with the increase of RWND, TCP throughout will first increase and then become saturated when RWND is more than the bandwidth-delay product (BDP).

FIG. 2 illustrates a TCP throughput diagram 211, a TCP RTT diagram 212 and a TCP control state change line 213. The state change line 213 crosses a sweet spot for TCP control. As illustrated in FIG. 2, when RWND is less than BDP, the TCP clients stays in the TCP throughput unstable state 201. Otherwise, the TCP client enters and stays in the stable state 202. In state 201, TCP throughput can continue to grow by increasing RWND since we have reached the link bottleneck bandwidth. Therefore, a sweet spot of RWND operation is to select the RWND that has the minimum TCP RTT while reaching the maximum TCP throughput. In stable 202, TCP client may decrease its RWDN size.

However, the BDP may vary due to the change of TCP bandwidth, which depends on many issues such as the number of bandwidth competitors and channel conditions. Hence, it is impractical to directly set RWND as BDP since BDP varies with time. A top-level method is provided in FIG. 3.

FIG. 3 illustrates a flow diagram for the TCP buffer over bloat resolution based on the TCP throughput stability in accordance to embodiments of the current invention. At step 301, the TCP client receives TCP packets from a TCP server. At step 302, the TCP client monitors a TCP throughput for this TCP link. At step 303, the TCP client determines the stability of the TCP throughput based on the measured TCP throughput. In one embodiment, the TCP throughput stability is determined further based on an estimation of the current throughput based on the measured TCP throughput. At step 310, the TCP client checks if the TCP throughput is stable. If step 310 determines that the TCP throughput is not stable, it enters step 321 and increases the RWDN size. If step 310 determines that the TCP throughput is stable, it enters step 322 and decreases the RWDN size. Subsequently, at step 330, the TCP client sends the updated RWDN size value to the TCP server.

In one embodiment, the TCP client maintains a TCP throughput stability state so optimize the value of RWDN size.

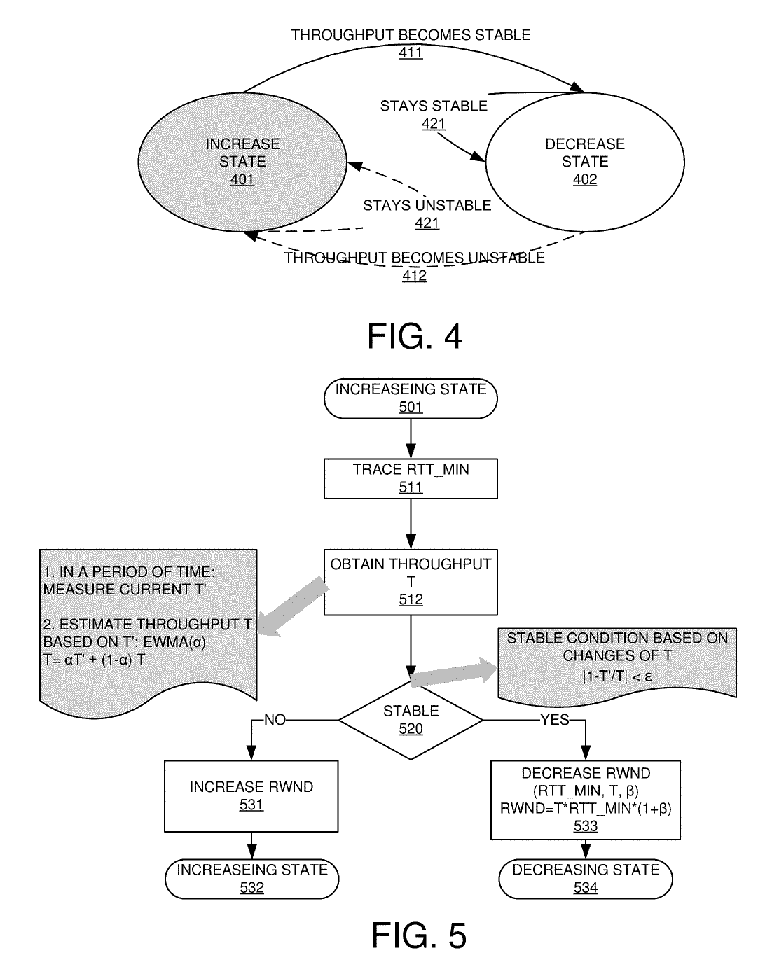

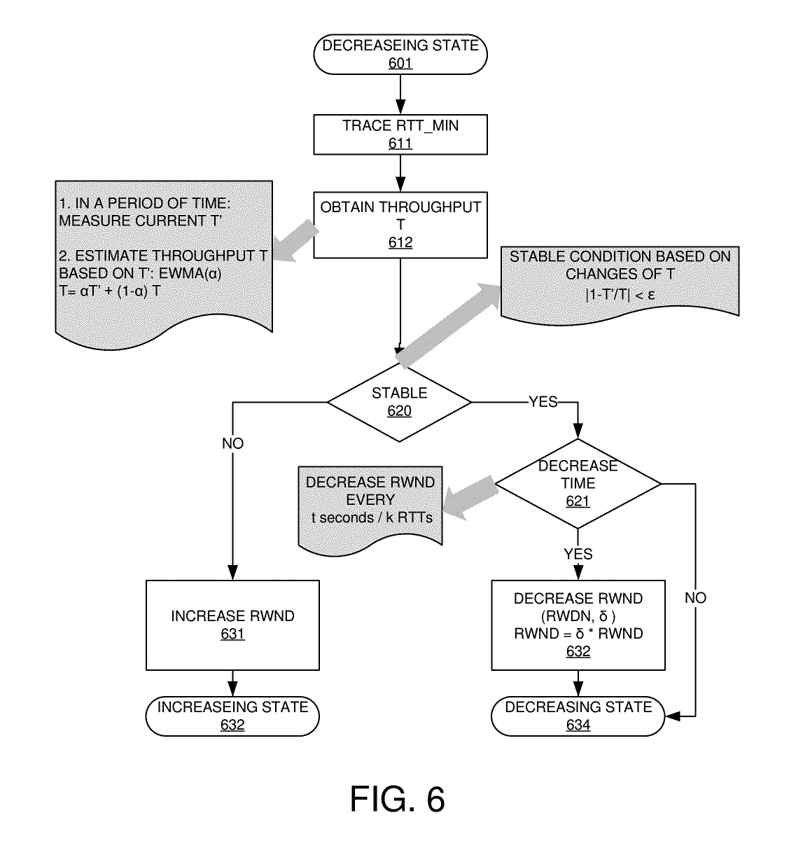

FIG. 4 illustrates an exemplary TCP throughput stability state transition diagram in accordance with embodiments of the current invention. The TCP client maintains an increase state 401 and a decrease state 402. While in decrease state 402, upon determining the TCP throughput is unstable, the TCP client enters increase state 401 at step 412. While in increase state 401, the TCP client enters decrease state 402 upon detecting TCP throughput becomes stable at step 411. If the TCP client is in increase state 401 and determines, at step 421, that the TCP throughput stays unstable, the TCP client stays in increase state 401. If the TCP client is in decrease state 402 and determines, at step 422, that the TCP throughput stays stable, the TCP client stays in decrease state 402. In one embodiment, the RWDN size is increased using the default RWND adjustment method of the existing TCP implementation. In another embodiment, the TCP client decreases the RWDN size following different method for states 401 and 402. FIG. 5 and FIG. 6 illustrate the differences of implementations.

FIG. 5 illustrates an exemplary flow chart for RWDN size management based on the TCP throughput stability with the TCP client in the increasing state in accordance with embodiments of the current invention. At step 501, the TCP client enters the increasing state. At step 511, the TCP client traces the minimum value of the RTT for the TCP link and obtains the RTTₘᵢₙ. At step 512, the TCP client obtains a current TCP throughput T. In one embodiment, an average throughput is measured by the TCP client for a predefined period of time. In one embodiment, the throughput T is estimated using the exponential weighted moving average (EWMA) with an EWMA coefficient for per-link throughput estimation α. In one embodiment, T=αT′+(1−α)T. At step 520, the TCP client determines if the TCP throughput is stable. In one embodiment, the stability is determined based on the change rate of the TCP throughput obtained at step 512. In another embodiment, the stability is determined further based on a predefined throughput stability definition value ε. The threshold of throughput changing rate depends on the network environment In one embodiment, the threshold of throughput changing rate is compared to the ε to determine the stability of the throughput. If |1−T′/T|<ε is true, the TCP throughput is determined to be stable. If step 520 determines no, the TCP client moves to step 531 and increases the RWDN size. In one embodiment, the TCP client increases the RWDN size using the default RWND adjustment method of the existing TCP implementation. Subsequently, the TCP client stays in the increasing state at step 532. If step 520 determines yes, the TCP client moves to step 533 to decrease the RWDN size. In one embodiment, the TCP client decreases the RWDN window based on the obtained minimum RTT value, the obtained throughput T and an appropriate RWND estimation upper bound factor β. In one embodiment, the decreased RWDN size is set as: RWND=T*RTTₘᵢₙ*(1+β). Subsequently, the TCP client enters in the decreasing state at step 534.

FIG. 6 illustrates an exemplary flow chart for RWDN size management based on the TCP throughput stability with the TCP client in the decrease state in accordance with embodiments of the current invention. At step 601, the TCP client enters the decreasing state. At step 611, the TCP client traces the minimum value of the RTT for the TCP link and obtains the RTTₘᵢₙ. At step 612, the TCP client obtains a current TCP throughput T. In one embodiment, an average throughput is measured by the TCP client for a predefined period of time. In one embodiment, the throughput T is estimated using the EWMA with an EWMA coefficient for per-link throughput estimation α. In one embodiment, T=αT′+(1−α)T. At step 620, the TCP client determines if the TCP throughput is stable. In one embodiment, the stability is determined based on the change rate of the TCP throughput obtained at step 612. In another embodiment, the stability is determined further based on a predefined throughput stability definition value ε. If step 620 determines no, the TCP client moves to step 631 and increases the RWDN size. In one embodiment, the TCP client increases the RWDN size using the default RWND adjustment method of the existing TCP implementation. Subsequently, the TCP client enters the increasing state at step 632. If step 620 determines yes, the TCP client moves to step 621 to determine if a decrease timer expires. In one embodiment, the decrease RWND timer is t seconds/k RTTs. The RWND decreasing time interval/timer t/k is predefined or preconfigured. The decrease timer is set when the last decreasing of RDWN is performed. If step 621 determines the timer is not expired, the TCP client moves step 634 and stays in the decreasing state. If step 621 determines yes, the TCP client moves to step 633 to decrease the RWDN size. In one embodiment, the TCP client decreases the RWDN window by a RWND decreasing ratio δ. In one embodiment, the decreased RWDN size is set as: RWND=δ*RWND. Subsequently, the TCP client stays in the decreasing state at step 634.

Table 1 summarizes exemplary parameters for RWND size handling in accordance with embodiments of the current invention.

| | Description |
|---|---|
| α | EWMA coefficient for per-link throughput estimation |
| ϵ | Throughput stability definition |
| β | Appropriate RWND estimation upper bound factor |
| δ | RWND decreasing ratio |
| t/k | RWND decreasing time interval/timer |

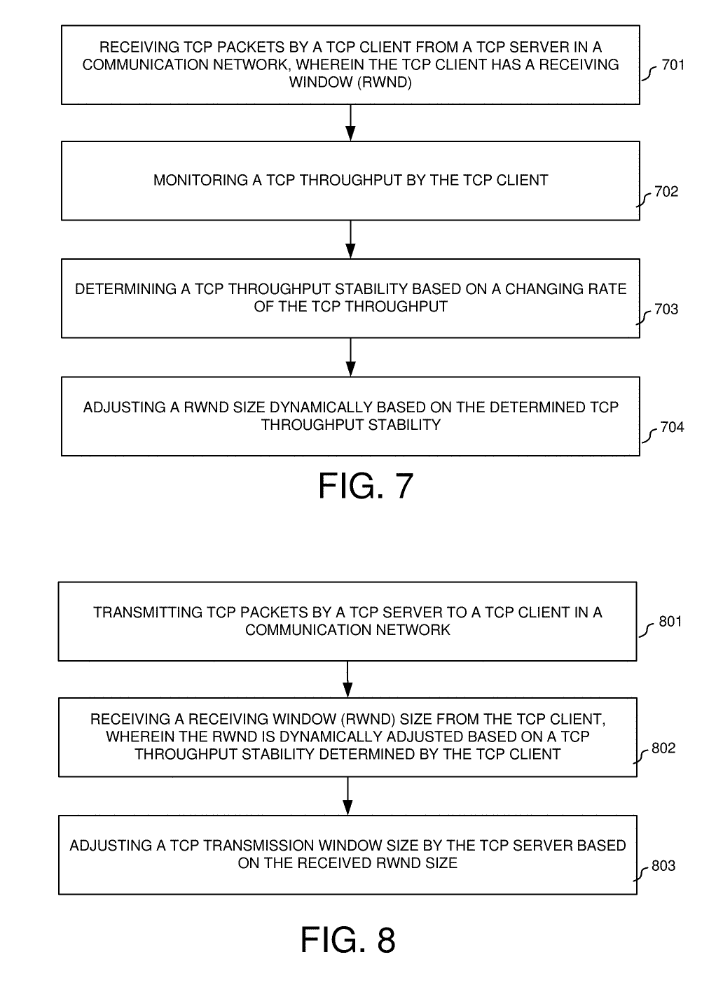

FIG. 7 illustrates an exemplary flow chart of a TCP client performing the TCP bufferbloat resolution in accordance with embodiments of the current invention. At step 701, the TCP client receiving TCP packets by a TCP client from a TCP server in a communication network, wherein the TCP client has a RWDN. At step 702, the TCP client monitors a TCP throughput. At step 703, the TCP client determines a TCP throughput stability based on a changing rate of the TCP throughput. At step 704, the TCP client adjusts a RWND size dynamically based on the determined TCP throughput stability.

FIG. 8 illustrates an exemplary flow chart of a TCP server performing the TCP bufferbloat resolution in accordance with embodiments of the current invention. At step 801, the TCP server transmits TCP packets to a TCP client in a communication network. At step 802, the TCP server receives a RWND size from the TCP client, wherein the RWND is dynamically adjusted based on a TCP throughput stability determined by the TCP client. At step 803, the TCP server adjusts a TCP transmission window size by the TCP server based on the received RWND size.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving TCP packets by a TCP client from a TCP server in a communication network, wherein the TCP client has a receiving window (RWND);
monitoring a TCP throughput by the TCP client;
determining a TCP throughput stability based on a changing rate of the TCP throughput; and
adjusting a RWND size dynamically based on the determined TCP throughput stability.

2. The method of claim 1, wherein the TCP throughput is stable if the changing rate of an increase or decrease of the TCP throughput is smaller than a threshold, otherwise, the TCP throughput is unstable.

3. The method of claim 2, wherein the changing rate is obtained based on a current throughput measurement of the TCP throughput for a predefined period, and an estimated exponential weighted moving average (EWMA) of the current throughput measurement.

4. The method of claim 2, wherein the adjusting the RWND size involves decreasing the RWND size if the TCP throughput is determined to be stable, otherwise increasing the RWND size.

5. The method of claim 2, further comprising: entering and staying in a decreasing state if the TCP throughput is determined to be stable, and entering and staying in an increasing state if the TCP throughput is determined to unstable.

6. The method of claim 5, wherein the RWND size is decreased when the TCP throughput is determined to be stable while the TCP client is in the increasing state, and wherein the reduced RWDN size is based on a minimum round trip time (RTT), an estimated exponential weighted moving average (EWMA) of a current throughput measurement, and a RWND estimation upper bound factor.

7. The method of claim 5, wherein the RWND size is decreased when the TCP throughput is determined to be stable while the TCP client is in the decreasing state, and wherein the RWDN size reduced by a RWND decreasing ratio based on a current RWDN size.

8. The method of claim 1, further comprising:
transmitting the adjusted RWND size to the TCP server in a TCP ACK header.

9. A method comprising:
transmitting TCP packets by a TCP server to a TCP client in a communication network;
receiving a receiving window (RWND) size from the TCP client, wherein the RWND is dynamically adjusted based on a TCP throughput stability determined by the TCP client; and
adjusting a TCP transmission window size by the TCP server based on the received RWND size.

10. The method of claim 9, wherein the TCP client determines that the TCP throughput is stable if the changing rate of an increase or decrease of the TCP throughput is smaller than a threshold, otherwise, the TCP throughput is unstable.

11. The method of claim 10, wherein the changing rate is obtained based on a current throughput measurement of the TCP throughput for a predefined period, and an estimated exponential weighted moving average (EWMA) of the current throughput measurement.

12. The method of claim 10, wherein the RWND size is decreased if the TCP throughput is determined to be stable, otherwise the RWND size is increased.

13. The method of claim 9, wherein the adjusted RWND size is received by the TCP server in a TCP ACK header.

14. An apparatus, comprising:
a transceiver that transmits and receives TCP packets to and from a TCP server in a communication network;
a throughput monitor that monitors a TCP throughput;
a stability manager that determines a TCP throughput stability based on a changing rate of the TCP throughput; and
a receiving window (RWND) size adjuster that adjusts a RWND size dynamically based on the determined TCP throughput stability.

15. The apparatus of claim 14, wherein the TCP throughput is stable if the changing rate of an increase or decrease of the TCP throughput is smaller than a threshold, otherwise, the TCP throughput is unstable.

16. The apparatus of claim 15, wherein the changing rate is obtained based on a current throughput measurement of the TCP throughput for a predefined period, and an estimated exponential weighted moving average (EWMA) of the current throughput measurement.

17. The apparatus of claim 15, wherein the adjusting the RWND size involves decreasing the RWND size if the TCP throughput is determined to be stable, otherwise increasing the RWND size.

18. The apparatus of claim 15, further comprising: a state manger that enters and stays in a decreasing state if the TCP throughput is determined to be stable, and enters and stays in an increasing state if the TCP throughput is determined to unstable.

19. The apparatus of claim 18, wherein the RWND size is decreased when the TCP throughput is determined to be stable while the TCP client is in the increasing state, and wherein the reduced RWDN size is based on a minimum round-trip time (RTT), an estimated exponential weighted moving average (EWMA) of a current throughput measurement, and a RWND estimation upper bound factor.

20. The apparatus of claim 18, wherein the RWND size is decreased when the TCP throughput is determined to be stable while the TCP client is in the decreasing state, and wherein the RWDN size reduced by a RWND decreasing ratio based on a current RWDN size.

21. The apparatus of claim 14, wherein the transceiver transmits the adjusted RWND size to the TCP server in a TCP ACK header.
